(19) United States
(12) Patent Application Publication
(10) Pub. No.: US 2005/0267809 A1
(43) Pub. Date: Dec. 1, 2005

(54) System, method and computer program product for presenting advertising alerts to a user

(76) Inventor: Zhiliang Zheng, Sunnyvale, CA (US)

Correspondence Address: SQUIRE, SANDERS & DEMPSEY L.L.P, 600 HANSEN WAY, PALO ALTO, CA, 94304-1043, US

(21) Appl. No.: 11/142,510

(22) Filed: May 31, 2005

Related U.S. Application Data
(60) Provisional application No. 60/576,049, filed on Jun. 1, 2004.
(60) Provisional application No. 60/623,980, filed on Nov. 1, 2004.

(51) Int. Cl. G06F 17/60

(52) U.S. Cl. 705/14

(57) ABSTRACT

Embodiments are described for a system, method and computer program product for presenting advertising alerts to a user based on items of interest to the user. In one embodiment, information is obtained about one or more items of interest to a user. For each item, the user is permitted to select whether to receive advertising alerts relating to the item. Subsequently, a determination may be made as to whether a promotion is available for an item selected to receive advertising alerts. When a promotion is available, the user is presented with an advertising alert about the promotion.

### CROSS REFERENCES TO RELATED APPLICATIONS

This application claims the benefit U.S. Provisional Application No. 60/576,049, filed Jun. 1, 2004, and U.S. Provisional Application No. 60/623,980, filed Nov. 1, 2004, both of which are incorporated by reference herein in their entirety.

### TECHNICAL FIELD

Embodiments described herein relate generally to electronic shopping and, more particularly, to the targeting of information.

### BACKGROUND

Advertising using traditional media, such as television, radio, newspapers and magazines, is known. Advertisers have used these types of media to reach a large audience with their advertisements. To reach a more responsive audience, advertisers have used demographic studies. For example, advertisers may use broadcast events such as football games to advertise beer and action movies to a younger male audience. However, even with demographic studies and entirely reasonable assumptions about the typical audience of various media outlets, advertisers recognize that much of their ad budget is simply wasted because the target audience is not interested in the ad they are receiving.

Interactive media, such as the Internet, has the potential for better targeting of advertisements. For example, some websites provide an information search functionality that is based on query keywords entered by the user seeking information. This user query can be used as an indicator of the type of information of interest to the user. By comparing the user query to a list of keywords specified by an advertiser, it is possible to provide some form of targeted advertisements to these search service users. The effectiveness may be limited to sites where the user enters a search query to indicate their topic of interest.

Other known system identifying targeting information for an advertisement, analyzing the content of a target document to identify a list one or more topics for the target document, comparing the targeting information to the list of topics to determine if a match exists, and determining the advertisement is relevant to the target document if the match exists. The effectiveness may be limited to sites where user trying to view the site.

### SUMMARY

Embodiments are described for a system, method and computer program product for presenting advertising alerts to a user based on items of interest to the user. In one embodiment, information is obtained about one or more items of interest to a user. For each item, the user is permitted to select whether to receive advertising alerts relating to the item. Subsequently, a determination may be made as to whether a promotion is available for an item selected to receive advertising alerts. When a promotion is available, the user is presented with an advertising alert about the promotion.

In one embodiment, the user may be permitted to specify criteria for selecting promotions. In such an embodiment, the determination may further include a determination as to whether the available promotion satisfies at least a portion of the criteria specified by the user so that the advertising alert may be presented for promotions that satisfy the portion of the criteria.

In one embodiment, the advertising alert may be transmitted to a wireless device of the user. In another embodiment, the advertising alert may be presented to the user via a network.

In a further embodiment, the determination may further include registering a seller in order to permit the seller to submit promotions for goods and services associated with the seller. In such an embodiment, a determination may be made as to whether any of the submitted promotions of the seller matches one of the items selected by the user to receive advertising alerts so that the advertising alert presented to the user may be associated with at least one submitted promotion that was determined to match one of the items submitted by the user. As an option, the user may also be permitted to contact the seller via a network.

In one embodiment, one or more third party sites may be searched for promotions that will expire within a predetermined amount of time. A determination may be made as to whether the promotion is directed to one or more of the items obtained from the user. The user may then be presented with an advertising alert relating to the promotion. In such an embodiment, the one or more items to which the promotion can include at least one item that the user chose not to receive advertising alerts.

In one embodiment, one or more third party sites may be searched for new update information associated with at least one item obtained from the user. The user may then be presented with an alert that indicates the availability of the new update information. In another embodiment, a magazine may be generated that contains the promotions determined to be available, and wherein the magazine is presented to the user. As an option, the magazine may comprise an online magazine. The magazine may also contain identifiers associated with the promotions included in the magazine. The magazine may further include promotions for additional recommended items that are selected based on an association to the items for which promotions are determined to be available.

In one embodiment, the information for each item may further include information about one or more characteristics of the item. In such an embodiment, the determining whether a promotion is available may include searching for promotions that relate to the information about the one or more characteristics of the item. In another embodiment, the user may be permitted to assign each item to one or more categories of need so that the items may be organized into a plurality of lists according to the assigned categories of need. The plurality of lists may then be presented to the user so that the user can review items assigned to the same category of need in the list associated with the given category of need. In such an embodiment, the advertising alert may be presented in the list(s) in which the item is assigned.

In one embodiment, the promotion that is determined to be available may require an identifier associated with the user to be disclosed when redeeming the promotion. In another embodiment, the user may forward the advertising alert to a third party. If and when the third party accesses the promotion utilizing the advertising alert, the user may then be assigned a credit for the access by the third party with the value of the credit being assigned based on at least a degree of relatedness of the third party to the user.

### BRIEF DESCRIPTION OF THE DRAWINGS

FIG. 1 is a block diagram illustrating an exemplary environment in which embodiments described herein may be implemented;

FIG. 2 is a functional block diagram illustrating a universal network market system in accordance with an exemplary embodiment;

FIG. 3 is a block diagram of an exemplary architecture for implementing embodiments of the universal network market system;

FIG. 4 is a flowchart of a process for providing targeted advertising in accordance with an exemplary embodiment;

FIG. 5 is a block diagram of an illustrative categorized shopping list that may be used as a shopping organizer in accordance with an exemplary embodiment;

FIG. 6 is an illustrative “My Immediate” shopping list of a representative buyer in accordance with an exemplary embodiment;

FIG. 7 is an illustrative buyer's service request list in accordance with an exemplary embodiment;

FIG. 8 is an illustrative item requirement list in accordance with an exemplary embodiment;

FIG. 9 presents an illustrative shopping expert that may be presented to a user by a universal network market system in accordance with an exemplary embodiment;

FIG. 10 shows illustrative tables that may be used to provide customer-oriented advertisements in accordance with an exemplary embodiment;

FIG. 11 is an exemplary timing-critical advertisement that may be presented to a buyer in accordance with one embodiment;

FIG. 12 is an illustration of a table that may be used by a universal network market system to conduct a direct selling event in accordance with an exemplary embodiment;

FIG. 13 is an illustrative Customer-Specific Advertisement Magazine in accordance with an exemplary embodiment;

FIG. 14 is an example of a table that may be used to generate ID-related coupons in accordance with an illustrative embodiment;

FIG. 15 is a table that may be used to afford an efficient advertisement reward referral system in accordance with an exemplary embodiment;

FIG. 16 is an example of an illustrative Linked Raking System in accordance with an exemplary embodiment;

FIG. 17 is an example of a Menu/Installation Software table that may be afforded by a universal network market system in accordance with one embodiment;

FIG. 18 is an exemplary browser/toolbar for a universal network market system in accordance with one embodiment;

FIG. 19 is a flowchart of a process for organizing items of interest for presentment to a user in accordance with an exemplary embodiment;

FIG. 20 is a flowchart of a process for presenting advertising alerts to a user based on items of interest to the user in accordance with an exemplary embodiment;

FIG. 21 is a flowchart of a process for purchasing items in accordance with an exemplary embodiment;

FIG. 22 is a schematic diagram of an illustrative network system in accordance with an exemplary embodiment; and

FIG. 23 is a schematic diagram of a representative hardware environment in accordance with one embodiment.

### DETAILED DESCRIPTION

In general, embodiments of a universal market network system that can provide expert criteria for assisting a shopper and provide a means for permitting users track and organize shopping items. Embodiments of the universal market network system may also be capable of providing users with timing-critical targeted advertising. U.S. Provisional Application No. 60/576,049, filed Jun. 1, 2004, and U.S. Provisional Application No. 60/623,980, filed Nov. 1, 2004 are both incorporated by reference herein in their entirety.

### Environment and Architecture

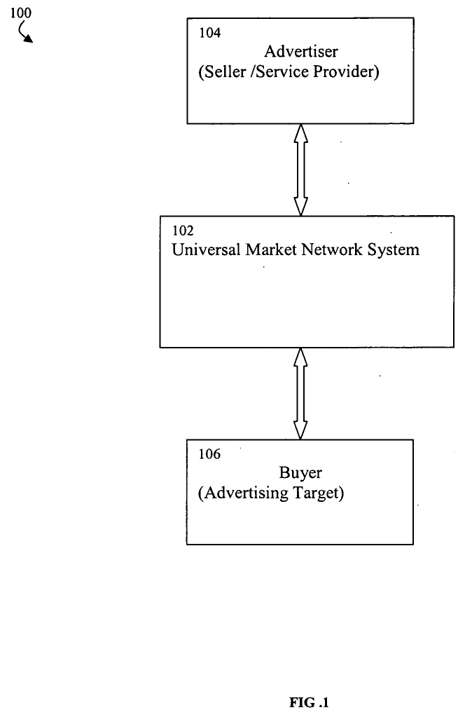

FIG. 1 is a block diagram illustrating an exemplary environment 100 in which embodiments described herein may be implemented. The exemplary environment comprises a universal market network system 102 that is coupled to one or more advertisers 104 and one or more advertising targets 106 or buyers. As shown in FIG. 1, an advertiser 104 may comprise a seller or service provider and/or a party that provides advertising services on behalf of a seller or service provider. The universal network market system 100 may also be referred to herein as a shopping and advertising system and provides an interface between the advertisers 104 (and thus sellers/service providers) and potential buyers 106 of goods and services, namely, advertising targets to which advertisements for goods and services are intended to be directed to.

### Business Operation

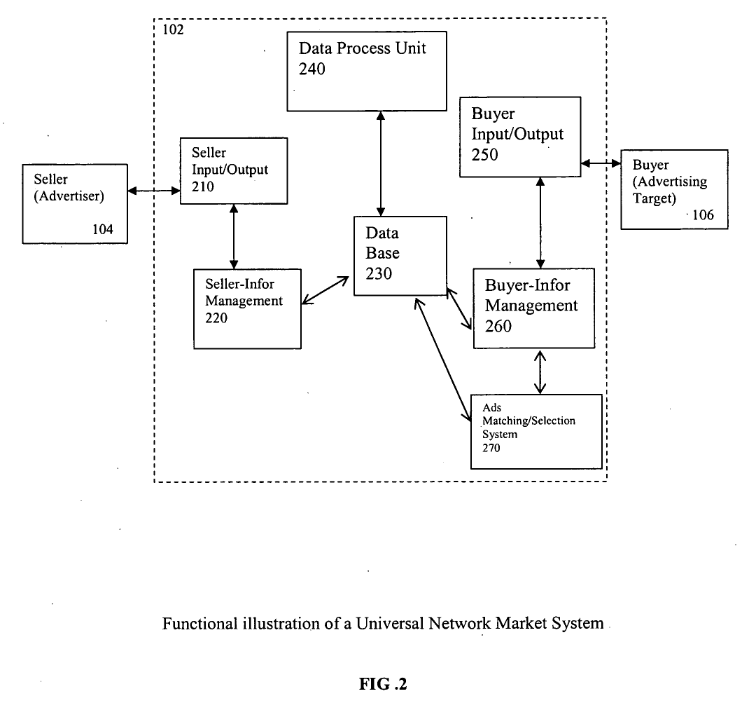

FIG. 2 is a functional block diagram illustrating a universal network market system 102 in accordance with an exemplary embodiment. The universal network market system 102 may provide one or more of the following functions/services: market system customer-oriented advertisements, finding timing critical advertisements, direct selling with minimum inventory, providing customer-specific advertisement magazines, ID-related coupons, an efficient advertising reward referral system, and a linked rating system. To carry out these functions/servers, the universal network market system 102 may include (as shown in FIG. 2) a seller/advertiser input/output (I/O) component 210 for interfacing with one or more sellers/advertisers 104, a seller/advertiser management component 220, one or more databases 230, one or more data processing units 240, a buyer/advertising target management component 260, and a buyer/advertising target I/O component 250 for interfacing with one or more buyers/advertising targets 106. The buyer/advertising target management component 260 also may include a shopping expert and a shopping list. The universal network market system 102 may also include an advertisement selection system/component 270 for implementing various advertisement selection-related features of the universal network market system 102.

The functions/servers, the universal network market system may be provided utilizing the buyer/advertising management component 260, data processing unit 240, and seller/advertiser management component 220 and the advertisement selection component 270.

The universal network market system may be utilized to build a company that has connection with, for example, commercial/merchant companies and financial companies. The company can use the universal market system to provide services to individual person or company. Such services may include, for example, providing shopping experts, providing shopping lists, providing customer-oriented advertisements, and permitting direct selling with minimum inventory for any product.

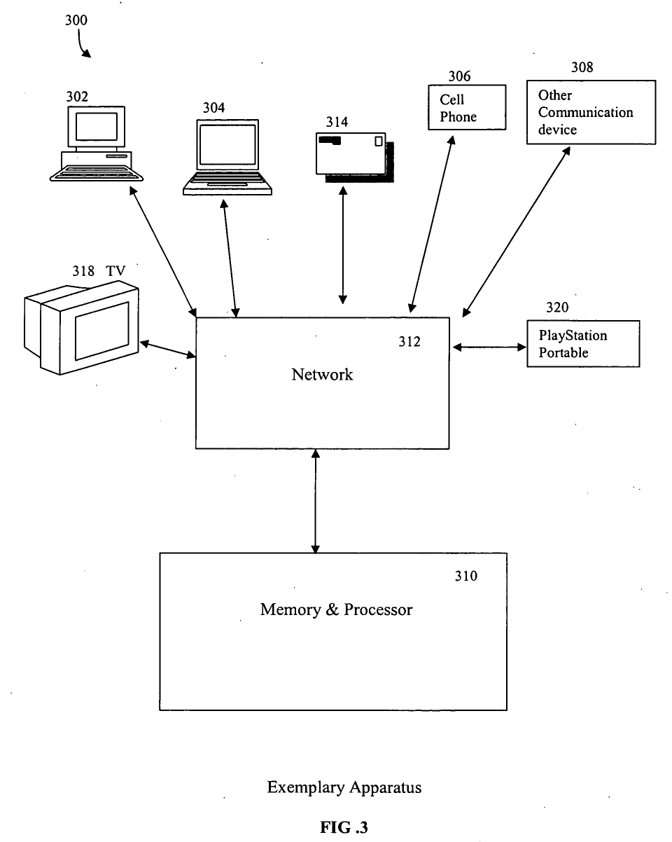

FIG. 3 is a block diagram of an exemplary architecture 300 for implementing embodiments of the universal network market system. As shown in FIG. 3, the architecture 300 may includes multiple client devices 302, 304, 306, 308, 318, 320 or clients, a server device 310 (i.e., a server) and a network 312. The buyer and sellers of the universal network market system may be implemented as clients while the universal network market may be implemented by the server. Client devices may comprise computers, handheld devices, phone cameras, or any other computing devices that can obtain access to the server via the network. By using a client device, a client can look at/read shopping items (e.g., products/services) and then put selected products/services that they are interested in into a shopping list.

Client devices may also include a bar code scanning component to permit the scanning and reading of bar codes. In a mobile phone implementation of a client, the bard code scanning component may be implemented in part using a digital cameral component included in the mobile phone. In such an implementation, the bar code component may be used to read a bar codes presented with the shopping items in order to obtain information about the product/service that the client is interested in and that can be displayed to the client on a visual display component of the client device (e.g., information may pop-up automatically over a display of a mobile phone). Items that are displayed on the client device may then be selected by the client moved into the client's shopping list. In an implementation where radio frequency identification (RFID) technology is used, a client device may include a component capable of reading RFIDs attached to a product/service. The information read from the RFID may then be used to obtain information corresponding to the chosen product/service and display that information to the client so that the client can select products/services for inclusion in the client's shopping list.

The universal network market system may use a variety of communication channel such as, for example, the Internet, telephone networks, e-mail 314, television 318, Interactive television, interactive voice response (IVR), voice-over IP, call centers, store fronts, ATMs, kiosks, hand held devices and any other platform to conduct its business.

In one embodiment, the universal network market system may be implemented distributively on the clients and server over the network. In another embodiment, the universal network market system may be implemented locally on the clients over the network.

### Operation

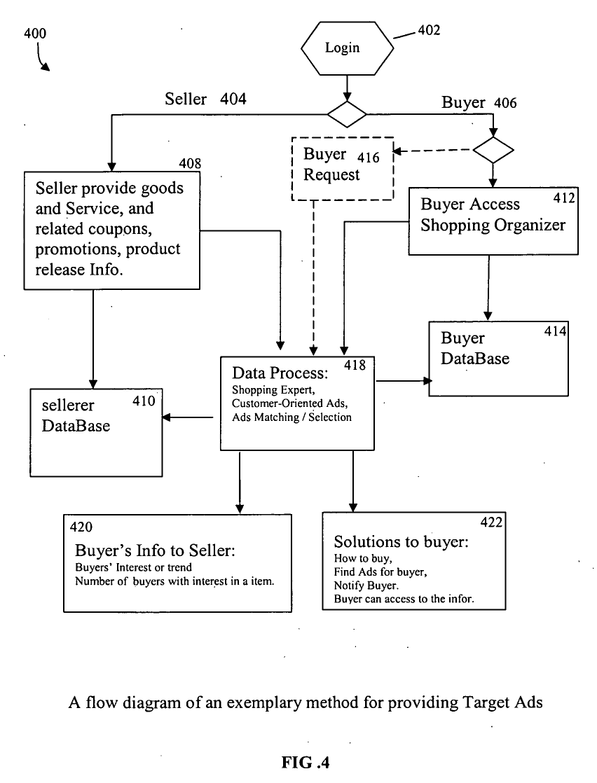

FIG. 4 is a flowchart of a process 400 for providing targeted advertising in accordance with an exemplary embodiment. Upon client login 402, the path taken through the process is dependent on whether the client is a seller/advertiser, in which case the seller path 404 is followed, or a buyer/advertising target in which case the buyer path 406 is followed.

If the seller path 404 is followed, then in block 408, the seller provides information to the universal network marketing system about goods and/or services the seller wishes to sell and/or advertise, coupons for the goods/service, promotion-related information, and product release related information. This information may then be stored in a seller database of the universal network market system (see block 410). If the buyer path 406 is followed, then in block 412, the buyer may access a shopping organizer/shopping list to provide information to and obtain information from the universal network market system. Information provided by the buyer may be stored in a buyer database of the universal network market system (see block 414). With either path 404, 406, information provided to the universal network market system (including, e.g., buyer requests 416) may be subject to one or more processes/functions (e.g., shopping expert functions, customer-orientated advertising functions, etc.) of the universal network market system in block 418 so that information about a buyer can be provided to a seller (see block 420) and information (e.g., solutions: how to buy, finding advertisements, etc.) from the universal network market system can be provided to a buyer (see block 422). By using this process 400, a seller can, for example, login to the system, get access to the shopping list/shopping organizer, and then use the shopping expert, customer-oriented advertisements and other services/functions of the universal network market system.

### Interface

Through a communication channel, a client can build a specific account with the universal network market system. An account may has a user-ID associated with it. If the client is a buyer/advertising target, then the buyer can login to the universal network market system using the associated user-ID to access the account and functionality/services of the universal network market system such as the shopping expert, the shopping list/shopping organizer, and customer-oriented-advertisemerits.

The buyer can also obtain help from the universal network market system on how to choose a product/service. For example, a buyer may provide the universal network market system with a list of products/services that the buyer is interested in and the universal network market system can then find the right product, brand, company for the buyer.

A product may be defined for purposes herein to include real products and/or any commercial or non-commercial services that a company or individual can provide. A product may also be referred to herein as an item.

Depending on the implementation, buyers can provide the universal network market system with their personal information such as mailing address, billing information, and email addresses in order to help enhance the buyer's experience with the universal network market system. However, the universal network market system can be implemented so that buyers can choose not to provide some or all of their personal information to the universal network market system and still obtain access to their accounts and functions/services of the universal network market system. For further privacy control, an account may be identified only by an ID.

Advertisements distributed by the universal network market system may be first routed to the universal network market system and then sent to a buyer's e-mail address or other address in such a manner that such distribution can be quickly disabled upon the buyer's request. This way, a buyer can choose to block or receive any sellers' advertisements.

A seller can also build an account in the universal network market system and provide the universal network market system with information about a variety of things including goods and services that the buyer wishes to sell/provide and advertise, the types of advertisements, coupons, product releases. Using this information, the universal network market system may then be able to identify prospective customers (i.e., buyers/advertising targets) for the buyer.

The universal network market system may also include functionality/components for checking other data sources (including the Internet/World Wide Web) for information related to the information about the buyers and/or sellers. Some exemplary information that may be collected includes, for example, information about other coupons offered by a seller as well as information about network browsing and shopping behaviors of a buyer. The information collected from these other data sources may be provided to buyers and/or sellers depending on the service.

### Shopping List (Buying List/Selling List)

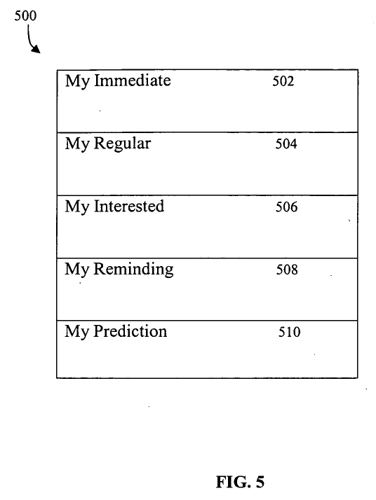

FIG. 5 is a block diagram of an illustrative categorized shopping list 500 that may be used as a shopping organizer in accordance with an exemplary embodiment. The shopping list is more than just a service for the clients to keep track of their shopping items. People can organize and manage their shopping items using the shopping organizer of the universal network market system. The shopping list is a place that a customer can keep track of whatever products/services that the customer is interested in obtaining or what the customer wants to purchase or use some time in the future. Buyers can look at whatever items that they are interested and put them in their shopping list.

In one embodiment, a small command/link: “Into shopping list” may be displayed adjacent goods and services presented to a customer so that the customer can review and select items by selection of the command. Thus, a buyer can simply click on “Into shopping list” adjacent a product/service to put the product/service into the buyer's shopping list. Inside the shopping list, buyer can choose whether or not to receive advertisements related to an item in the list. Via the shopping list, a buyer can also change the status of a “Wanna Ads” feature (which stands for Want to receive Advertisement or not) in the shopping list.

The universal network market system may initially present a template shopping list to a buyer. In one embodiment, buyers and/or sellers can provide suggested templates that may be used as the template shopping list. The universal network market system may permit a buyer to customize the template shopping list to suit the buyer's own individual needs and desires. Buyers may also be permitted to maintain multiple shopping lists based on their needs and desires. Some exemplary shopping lists are shown in FIG. 5 and include a “My Immediate” shopping list 502, a “My Regular” shopping list 504, a “My Interested” shopping list 506, a “My Reminding” shopping list 508 and even a “My Prediction” shopping list 510. The generated shopping list can use a shopping expert of the universal network market system to prepare information regarding the related price, item carrier, and product/service information for each item in the shopping list.

In one embodiment, default product expert criteria (e.g., a shopping expert) may be prepared for each item in the “My Immediate” shopping list 502 and the “My Regular” shopping list 504. With such a shopping list scheme, a buyer can go shopping using, for example, the buyer's “My Immediate” shopping list 502. Via the buyer's client device (e.g., a hand held computing device), the buyer may obtain access to the shopping expert and shopping list features of the universal network market system anywhere the buyer's device is in communication with the universal network market system.

In one embodiment a general list may be prepared for a client buyer. A general list may comprise a category of all possible products and service that are known to the universal network market system. A purpose of the general list is to help a buyer build up the buyer's own “My Immediate” shopping list 502, “My Regular” shopping list 504 and/or “My Reminding” shopping list 508. The buyer can review items presented (i.e., listed) in the general list, and then move whatever item to the buyer's “My Immediate” shopping list 502 and/or “My Regular” shopping list 504. The “My Interested” and “My Prediction” shopping lists 506, 510 may be used by the universal network market system to attempt to predict what the buyer may need based on a shopping profile of the buyer maintained by the universal network market system. Additional shopping list can be built according to a given buyer's needs or desires.

Any particular item can belong to one or more category of shopping list. For example, a staple product such as rice or milk can belong to the “My Immediate” and “My Regular” shopping lists 502, 504 at the same time while a digital camera, on the other hand, may just be included in the “My Interested” shopping list 506 since it may be considered more of a specialty item.

The exemplary categorized shopping list (i.e., the shopping organizer) 500 shown in FIG. 5 may be presented to a user via a visual display of the client device used by the buyer. The shopping lists 502, 504, 506, 508, 510 included in the categorized shopping list 500 may each contain a user-selectable link to permit the user to access and display a given shopping list upon selection of the associated link.

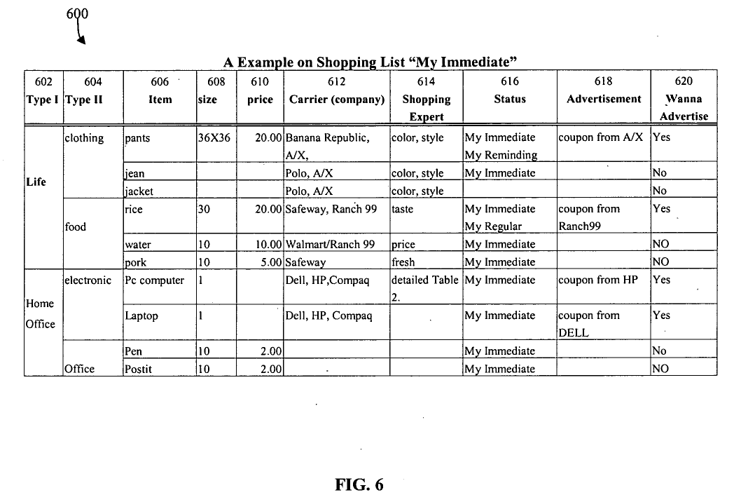

FIG. 6 is an illustrative “My Immediate” shopping list 600 of a representative buyer in accordance with an exemplary embodiment. Such a list 600 may be presented to a buyer upon selection of the associated link of the “My Immediate” shopping list 502 shown in FIG. 5. The “My Immediate” shopping list 600 shown in FIG. 6 presents a list of all of the items that a buyer may want to purchase or obtain immediately (or at least in the near future). Thus, a buyer can go shopping using the “My Immediate” shopping list 600 in order to help remind the buyer of the items that are most desirable to the buyer and thereby facilitate/make more convenient a buyer's shopping experience.

The universal network market system may initially provide a buyer/user with a template for any given shopping list so that the buyer can immediately begin using the list and input items into the list. The universal network market system may also permit a user to customize and alter these templates to suit the needs of a given buyer/user. As shown in FIG. 6, an exemplary version of a template for the “My Immediate” shopping list 600 may include the following columns for presenting corresponding information about items on the list: Type I 602, Type II 604, Item 606, Size 608, Price 610, Carrier 612, Shopping Expert 614, Status 616, Advertisement 618, and Wanna Advertise 620. As previously mentioned, the universal network market system may permit a buyer to customize the buyer's “My Immediate” shopping list 600. In addition, a buyer may be permitted to add and/or remove items from the “My Immediate” shopping list 600.

The Type I and Type II columns 602, 604 allow categorization of items in the lists. Some exemplary Type I categories include Life and Home Office. Type II categories may comprise subcategories to an associated Type I category. Some exemplary Type II categories include clothing, food, electronics and office supplies.

The columns for size, price, carrier and shopping expert (columns 608, 610, 612, 614) include parameters that buyers can use to decide products listed in the item column 606.

The Status column 616 identifies to which shopping lists does the associated item belong in (e.g., whether the item should be included in My Immediate, My Regular, My Interest, My Reminding, My Predicting lists (see FIG. 5)). Since an item can belong to one or more of these lists, the status column can include multiple lists in the entry of any give item.

The Wanna Advertise column 620 is a column into which a buyer/user can specify whether to allow the universal network market system to find and send the buyer advertisements somehow relating to the associated item. As shown in FIG. 6, the Wanna Advertise field may have two choices: “Yes”—indicating that the buyer is willing to receive advertisements and “No”—indicating that the buyer is not interested in receiving advertisements.

The entries for the Advertisement column 618 are where coupons that have been found for the associated item can be stored and identified (if the user selects “Yes” in the Wanna Advertise column 620 for the item). We will update buyer for timing critical Ads.

Further columns can be added to this exemplary template to extend the services provided by the universal network market system.

The universal network system can also organize and present the “My Immediate” shopping list in a different format. For example, all of the items in the “My Immediate” shopping list can be organized according to shop/store (i.e., items that are available at Macy's can all be grouped together in one group while items that are available at Costco are grouped together in another group). This way, a buyer may be able to optimize their “shopping path,” in that that can focus their lists and simply shop store by store as necessary.

### “My Regular” Shopping List

The “My Regular” shopping list may be used to keep track a user's (e.g., a buyer) regular shopping behavior. For example, a person may need to regularly buy food, water, clothing, toiletries (e.g., toothpaste, toothbrush, toilette paper) as well as pay bills for utilities and other services. Such times can be grouped together in the user's “My Regular” shopping list.

The user's shopping behavior can then be set up to track a user's shopping habit related to any item that is listed in the user's “My Regular” shopping list. For example, if a user needs to buy one bag of rice, three tubes of toothpaste, five packs of napkins every three months (at, for instance, a given store such a Costco warehouse store for example), these items may be stored and organized in the My Regular shopping list for the user.

### “My Reminding” Shopping List

Once a general shopping list for a user is established along with a “My Immediate” and “My Regular” shopping lists for the user, the universal network market system can use this information to help identify/ascertain a user's shopping behavior and shopping habits by knowing what product/service a user needs to buy regularly (from these lists). In use, the universal network market system may check the user's “My Regular” shopping list frequently (i.e., periodically). Once the universal network market system identifies through its analysis that some items in the “My Regular” shopping list need to be purchased again by the user, the universal network market system can place those items in the a “My Reminding” or “My Reminder” shopping list. The universal network market system can also send a notification to the user to remind the user that some items (i.e., the items in the “My Reminding” list) in their list may need to be replenished in the near future. Once the user receives the notification, the user can then check the My Reminding shopping list to identify which items need replenishment.

The user can then move those necessary items to the user's “My Immediate” shopping list for immediate shopping.

Continuing with the earlier example, if the universal network market system knows that a user needs to buy one bag of rice, three tubes of toothpaste and five packs of napkins every three months at given store (e.g., Costco), then the universal network market system can place entries for the rice, toothpaste and napkins in the user's “My Reminding” shopping list every three months and remind the user when it is time to buy rice, toothpaste and napkins at Costco.

In one embodiment, the “My Reminder” shopping list may be used by users to intentionally keep things that they want to be reminded about. For example, a user may want to be reminded annually about a birthday (or birthday gift), anniversary, holiday, or even the filing of a patent before a statutory or other deadline.

### “My Interested” Shopping List

A user may selectively designate items for inclusion in the user's “My Interested” shopping list. In general, a user may place whatever items that the user is interested in “My Interested” shopping list. When placing an item in the “My Interested” shopping list, user may also select whether to receive advertisements for the item (e.g., the Wanna Advertise field)

### “My Prediction” Shopping List

The “My-Prediction” or “Predicting” shopping list is where the universal network market system can put items that the universal network market system predicts the user may need based on the user's shopping profile (i.e., the shopping behaviors captured from, for example, the user's various shopping lists). Cross-selling and up-selling of items can be achieved via the “My Prediction” list by having the universal network market system try to predict and present products/services and related product/service information that the user may be interested to the user.

In an implementation where buyer/users may be worried about privacy, the universal network market system may permit a user to set up an account with the universal network market system without the buyer having to include his or her personal information. In such a fashion, shopping lists in such an implementation can help improve a buyer's shopping experience without sacrificing the buyer's private information. Similar privacy can be afforded to sellers (e.g., commercial companies trying to sell a product or service) as well. For example, sellers can provide the universal network market system with items and services that they want to sell via the universal network market system. The universal network market system can then place the seller's information (e.g., information about a product, the product's release date and the product's applications as well as coupons for the product and other product/service information in the universal network market system).

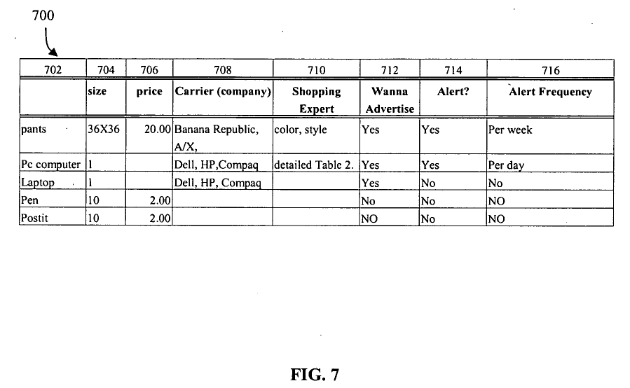

FIG. 7 is an illustrative buyer's service request list 700 in accordance with an exemplary embodiment. As shown in FIG. 7, the buyer's service request list 700 may include entries (e.g., rows) for items (as set forth in the items column 702) that includes columns for size 704, price 706, carrier 708, shopping expert 710 as well as “Wanna Advertise”, Alerts and Alert Frequency columns 712, 714, 716 for each item. The size, price, carrier, shopping expert and “Wanna Advertise” columns 704, 706, 708, 710, 712 are as previously described. Via the Alert and Alert Frequency columns, a user can specify whether to receive alerts for an item and the frequency for receiving such alerts. If the user select to receive alerts (i.e., a “Yes” for the item in the Alert column 714), the universal network market system can then provide alerts to the buyer about coupons that may be available for the item as well as product release information. These alerts can be transmitted to the buyer via, for example, telephone calls, text messaging, email and so on. This why a buyer can be notified about coupons and other product information quickly. The Alert Frequency column provides a buyer with an option to specify how often the buyer will be sent alerts (i.e., how often the buyer will be alerted).

With a buyer's service request list 700, a buyer can specify different services for different items. The service request list 700 can be extended to add or extend services as necessary.

In one implementation, the universal network market system may, for some timing critical advertisements, send alerts to buyers even when that chose not to receive alerts (i.e., selected the “No” option in the Alerts column 714). For example, if the universal network market system finds an online coupon for a laptop for the discounted price of US$100 that is valid for only three hours, the universal network market system may still update a buyer on this advertisement because its timing is critical.

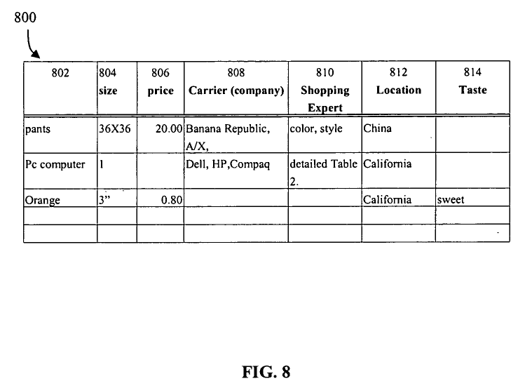

FIG. 8 is an illustrative item requirement list 800 in accordance with an exemplary embodiment. Like the buyer's service request, the item requirement list 800 may include columns for each item (listed in the item column 802) so that a buyer user can specify size 804, price 806, carrier 808, shopping expert 810 as well as location 812 and taste 814 for the items in the list. The location and taste columns 812, 814 allow a buyer to selectively define location and taste requirements for any item in the item requirement. For example, in the location column 812, the buyer can specify whether to receive alerts and other information for pants from China and oranges from California. With the taste column 814, the user may be able to specify sweet oranges rather than tart ones for example.

### Shopping Expert

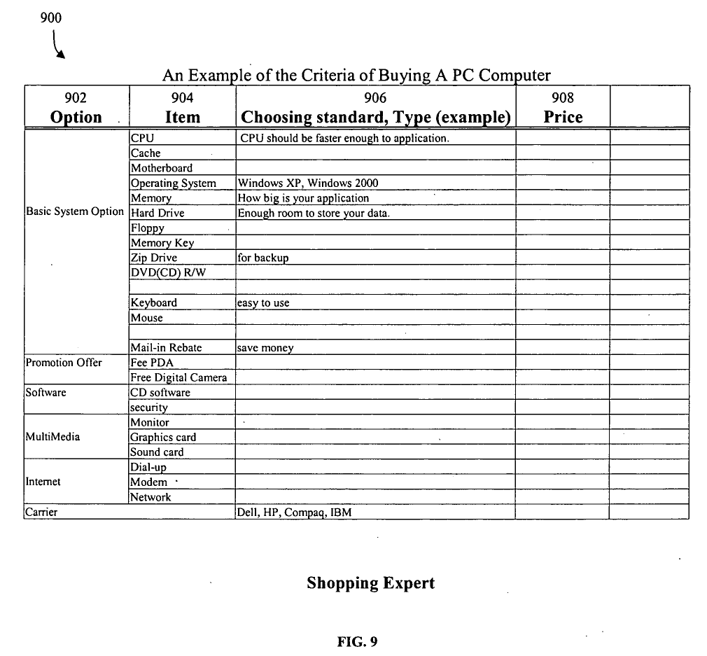

FIG. 9 presents an illustrative shopping expert 900 (which may also be referred to as “expert's criteria”) that may be presented to a user by a universal network market system in accordance with an exemplary embodiment. The universal network market system may utilize a shopping expert 900 to help educate a buyer on how to chose a given item or service. In the illustrative shopping expert 900, for example, information is presented to a user by the universal network market system on how to choose a personal computer (PC). As shown, the universal network market system may generate a shopping expert for a PC that presents various information about PC in a variety of rows and columns such as, for example, an option column 902, an item column 904, a choosing standard column 906 and a price column 908. The presented shopping expert 900 may also separate PC options into different rows (or sets of rows) such as, for example, a basic system options, promotion offers, software, multi-media, Internet and carrier. Other columns may be added to present further information to a user.

The information presented by the universal network market system in a shopping expert 900 is intended to provide the buyer with criteria for evaluating a product or service. The universal network market system may also use the shopping expert 900 to list products and/or services that meet various criteria established by the buyer (via, e.g., information provided in the buyer's request list), and to identify locations (e.g., shops/websites) where the products and/or services are available. Some additional exemplary criteria can include, budget, performance parameters, closest store and/or service provider.

Basically, by using a shopping expert, buyers can tell the universal network market system what they are interested in buying or what services they are interested receiving. The shopping expert can then be used by the universal network market system as a vehicle to present detailed information/criteria on how to choose a product or service to the buyer. The shopping expert component of the universal network market system may be interactive. For example, the shopping expert can be used to teach the buyer how to evaluate and choose a product or service. Once the buyer becomes familiar with the presented criteria, the shopping expert may be used to conduct an online-interview with the buyer and ask the buyer questions related to the product or service. The shopping expert can then be used to suggest a list of available products or services based on the buyers answers to the questions.

A shopping expert component of the universal network market system may categorize all the commercial products/services stored in the universal network market system, such as electronics, hardware, kitchen and books, or services. The shopping expert component of the universal network market system can then builds a product expert criteria form or page for each product/service. At the same time, the product and service database used by the shopping expert component can be continuously updated with, for example, the latest information on the best coupons for given products/services, the most attractive advertisements, the newest product releases and any other product/service related information. This way, the shopping expert component can response to buyers' requests quickly and precisely.

### Customer-Oriented Advertisements (One-to-One Marketing)

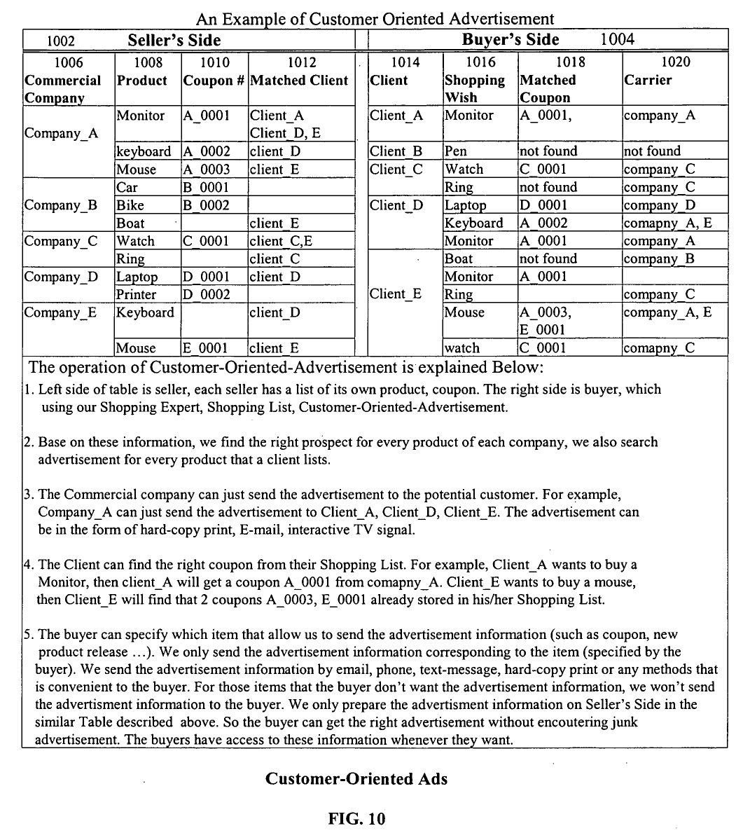

FIG. 10 shows illustrative tables that may be used to provide customer-oriented advertisements in accordance with an exemplary embodiment. The universal network market system may use such tables to search for advertisement to present to various buyers. Using such a system, presenting advertisements changes from a passive approach to an active approach where buyers identify to the universal network market system which items and services they are interested in receiving advertisements. Based on buyers' shopping lists, the universal network market system can determine what buyers need and what buyers will be most receptive to receiving offers from sellers. This way, the universal network market system can send the right advertisement to the buyer by electronics mail, iterative TV signal or hard-copy print or other communication channels. Via the universal network market system, buyers can receive the latest advertisement, coupon, bonus point, product releases they are interested in. As a result of such targeted advertising, a buyer may be more likely to read and give more attention to targeted advertisements.

To provide customer-oriented-advertisements, the universal network market system utilizes two tables: a seller table 1002 and buyer table 1004. The seller table 1002 includes entries for a plurality of sellers with the name of each seller identified in a commercial company column 1006. The seller table 1002 also includes product, coupon number and match client columns 1008, 1010, 1012 in which products of a given seller can be identified along with specific coupons that are associated with the given product and the identities of buyers (i.e., clients) that have been determined to be “matches” to the product (i.e., buyers that are most likely to be interested in receiving promotional information about the given product). The buyer table 1004 includes entries for a plurality of buyers (i.e., clients) with the name of each buyer identified in a client or buyer column 1014. The buyer table 1004 may also include columns 1016, 1018, 1020 for desired products (i.e., shopping wishes), coupons that match desired products and sellers associated with the matched coupons. number and match client columns 1008, 1010, 1012 in which products of a given seller can be identified along with specific coupons that are associated with the given product and the identities of buyers (i.e., clients) that have been determined to be “matches” to the product (i.e., buyers that are most likely to be interested in receiving promotional information about the given product).

Some or all of the columns of the buyer table 1004 can be populated with information obtained form the shopping expert and the buyer shopping lists. Based on this information, the universal network market system can find the right prospect for every product of each company. The universal network market system also can search for advertisement for every product that included in the buyer table 1004. Using these tables, a seller (e.g., a commercial company) can send a targeted advertisement to a potential customer. For example, using the tables 1002, 1004 shown in FIG. 10, Company_A can send an advertisement for a monitor to Client_A, Client_D, Client_E. The advertisement can be in the form of hard-copy print, E-mail, interactive TV signal.

The advertisement may also include or be linked a coupon having the code A_0001 so that it can be more easily identified and tracked. Using the tables shown in FIG. 10, the right coupons may be found by/provided to a buyer via his or her shopping list. For example, Client_A wants to buy a monitor. Client_A may receive a coupon A_0001 from company. Client_E wants to buy a mouse and, as a result, the universal network market system may include coupons A_0003, E_0001 in the shopping list of Client_E.

Using these tables 1002, 1004, universal network market system may allow a buyer to specify which item they are interested in and then send the advertisement information (such as coupon, new product release) associated with those items. The advertisement information may be sent by email, phone, text-message, hard-copy print or any methods that is convenient to the client. For those items that the client don't want the advertisement information, the universal network market system does not have to send any advertisements information to the client for that item.

Using the shopping list, we know exactly what product/service a buyer wants. A buyer can specify which item that they are willing to allow the universal network market system to send them advertisement and other information on (such as, for example, new products, product updates, events, promotions, special offers). The universal network market system can provide the advertisement information corresponding to the item as specified by the client. For those items that the buyer does not want to receive advertisement information, the universal network market system will not send such advertisements to the buyer.

With the tables 1002, 1004 shown in FIG. 10, the universal network market system has sufficient information on buyers and sellers so that effective management of buyer/seller information can be achieved—the universal network market system knows what buyers want to buy and what sellers can sell. Through such a table, a one-to-one market can be achieved.

Since the universal network market system has customer contact information, the universal network market system can help merchants (sellers) identify prospective buyers/customers. The universal network market system can be used to identify which customer are the most profitable to a given company. The universal network market system can also create a buyer's shopping profile and likely behavior of each buyer that can be used in a company's marketing effort.

Using the Customer-Oriented Advertisement approach facilitated by the universal network market system, sellers can achieve better advertising effects with less costs and effort. Cross-selling and up-selling can also be enhanced. Buyer's privacy does not have to be sacrificed since the universal network market system can be implemented to provide only user-IDs to buyers. In addition, contact between buyers and sellers may need to go through an communication channel of the universal network market system so that no advertisement will be able to reach the client without permission from the client. In one implementation, direct contact may between the seller and the buyer may be permitted if requested by a given buyer.

By using the Customer-Oriented Advertisement features of the universal network market system, commercial companies can identify the potential prospect/customer and send the advertisements to the right person. The universal network market system can create a client's shopping profile and likely behavior. All these can be valuable to a company's marketing effort.

Embodiments of the universal network market system can be implemented to minimize the interference with a user's shopping experience. In addition, the universal network market system can be used to achieve effective management of company (merchant)/customer information. By know what a buyer wants to buy, and what a seller can sell, the universal network market system can predict what type of product/service that a buyer may be interested.

In one embodiment, the universal network market system may reserve a portion of its user interface to present products/service that a buyer may be interested in (i.e., a cross selling opportunity). While a buyer is interacting with the universal network market system, the universal network market system may present information/advertisements about products/service intended to catch their intention. For example, if a buyer is looking for a coupon for a Dell laptop, the universal network market system can predict that the buyer may also be interested in a DELL printer. As a result, the universal network market system can present the latest advertisements, coupons, bonus points, product release information on various DELL printers to the buyer. The presentation of this information can be done in the reserved area of the interface so that the information won't interfere with the buyer's present shopping experience.

As an other feature, the universal network market system can prepare present a list of categorized items and their related information (using shopping expert, shopping list, customer-oriented advertisement components of the universal network market system) to the buyer. For example, when a buyer is using the universal network market system to obtain information about a ballet performance (e.g., the location of the performance and/or any specials for the ballet performance), the universal network market system can deduce that the buyer is interested in the performance. The universal network market system can then present the buyer with categorized information on this performance such as, for example, Type of Performance, Actors, Location, and Parking information.

The universal network market system may also be implemented to respect a user's privacy by requiring all communications between a buyer and a sell to go through the universal network market system unless the buyer requests direct communication with a seller and obtains the permission of the universal network market system to do so. Additional privacy is afforded because the buyer can choose what type of advertisements, products, companies, and brands that the buyer is interested in and block all other advertisements (e.g., via a buyer's request). Ads can be served or sent to a buyer through the universal network market system. In one embodiment, with the buyer's permission, the ads can be served/sent to buyer through any third-party, including the seller.

In sum, the Shopping Expert, shopping list, Customer-Oriented Advertisement may include information both from commercial companies and from all kinds of potential customers. By this way, a Virtual Link can be built through the universal network market system between commercial companies and their potential customers. This link allows a company (even small company) to build its own virtual sales force for any product, for even low-priced or low margin goods and services.

The Ads selection can be done at the background since the universal network market system may use buyer's stored information. The system may select Ads, promotions, production information for buyer while the buyer is using the network device or not using the network device. Then the system may send/present/serve the selected information to buyer, or keep the selected the information in the buyer's account. In one embodiment, such a process may be used to differentiate one of more aspects of the universal network market system from traditional search engines in that usually do their searching (or selecting) while a user is actively online.

### Finding Timing-Critical Advertisements and Information

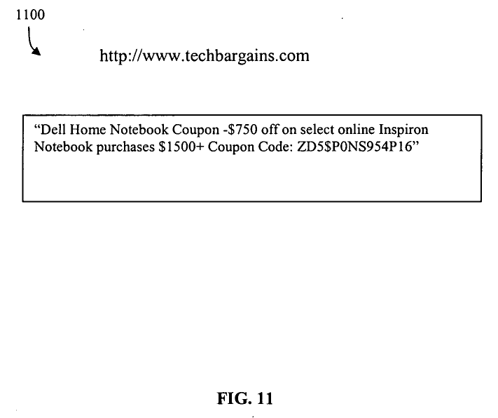

FIG. 11 is an exemplary timing-critical advertisement 1100 that may be presented to a buyer in accordance with one embodiment. Timing-critical advertisements may be provided by the universal network market system to present users with information/offers that they may not be aware of and that may last for a short duration. As an example, suppose there are several buyers using the universal network market system that indicate that there are interested in purchasing a discounted DELL laptop. If the universal network market system becomes aware of a short term promotion: “Dell Home Notebook Coupon −$750 off on select online Inspiron Notebook purchases $1500+ Coupon Code: ZD5$P0NS954P16” at “www.techbargains.com” on a given date. Most of traditional buyers would miss this advertisement because they either didn't know the web site “www.techbargains.com” or they didn't read the web site on that particular time when the promotion was being presented. In contrast, the universal network market system scans the websites of known sellers for promotions. These sellers may be identified, for example, as those listed in buyers' shopping lists maintained by the universal network market system. If a short term promotion is encountered, the universal network market system notifies buyers that have indicated in their shopping lists that they are interested in purchasing a Dell computer. This information can be relayed to the appropriate buyer via email, cell-phone, or a hand-held device.

The search for timing critical advertisements by the universal network market system may be conducted by searching sites of companies identified in the shopping lists of the buyer-users of the universal network market system as well as the sites of seller-users of the universal network market system. When an advertisement is found, the universal network market system can match the advertisement to buyers and sellers based on the buyer and seller profiles. In one implementation, the timing critical advertising component of the universal network market system may include a search engine for advertisements. The universal network market system may search for items (product, product release, product information, promotions) available from sources other than from sellers having a seller's account with the universal network system. In one aspect, portions or all of this kind of search may be performed by a computer or by a human being.

Once the universal network market system has found a timing-critical advertising, the universal network market system will alert buyers it has matched to the advertisement to inform these buyers of the special offer.

### Direct Selling with Minimum Product Inventory

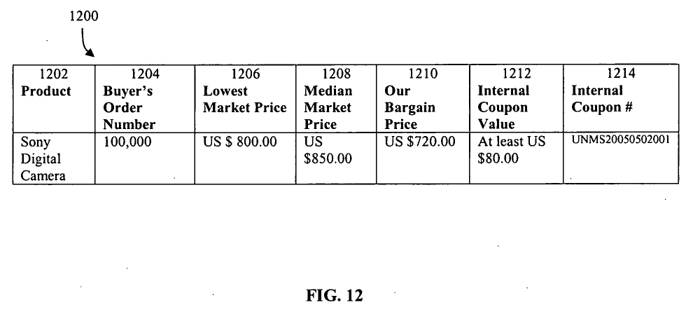

FIG. 12 is an illustration of a table 1200 that may be used by a universal network market system to conduct a direct selling event in accordance with an exemplary embodiment. When the universal network market system has several (i.e., one or more) buyers including the same product or service in their shopping list, the universal network market system may undertake an effort to buy the product/service directly from its seller/manufacturer/provider at a lower price than would be available through traditional retail channels. This may be possible because the number of orders for the given item could be significant. The universal network market system may collect information from its buyer-user's shopping lists to ascertain a common or maximum purchase price at which the buyers would consider purchasing the product. In the example shown in FIG. 12, the product 1202 could be a digital cameral from Sony Corp. The table may include columns (i.e., fields) for the number of interested buyers 1204, the lowest market price 1206 (i.e., retail price) for the product, the median retail price 1208 for the product, a bargain price 1210 offered by the universal network market system, a value 1212 of an internal coupon and identification number 1214 of the internal coupon. In the example shown in FIG. 12, because of the large number of interested buyers, the universal network market system could hypothetically negotiate a bargain price that is $80 lower than the lowest retail price. One way that the bargain price can be offered to buyer-users of the universal network market system is to generate and send a coupon (with its coupon identification number) for the $80 discount to the buyers. The coupon identifier may be assigned to the coupon by the universal network market system when the coupon is generated by the universal network market system. One advantage of this bargain feature is that the universal network market system can determine the number of highly likely sales from the shopping lists of its buyers by identifying those buyers that include a camera in their “My Immediate” shopping list for example. This also helps to keep inventory of the product at the universal network market system down to a low minimum so that large warehousing costs are not incurred by the universal network market system (and such savings can be passed on in the lower bargain price).

In one embodiment, the universal network market system may provide the likely sales information to a seller/manufacturer/provider so that they can better control their inventory and production line.

### Generating a Brochure of Customer-Specific Advertisements Soft-Copy Or Hard-Copy

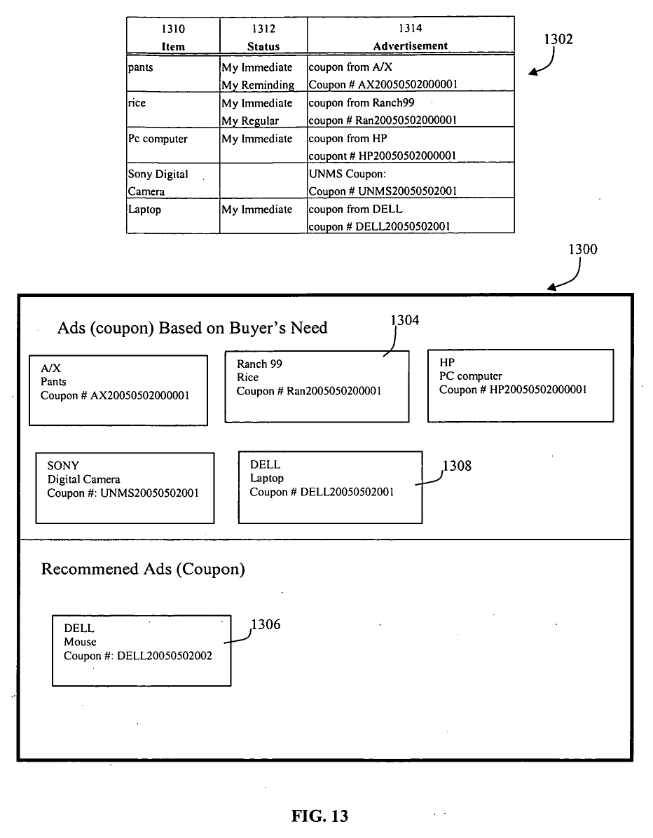

FIG. 13 is an illustrative Customer-Specific Advertisement Magazine 1300 that may be generated by an exemplary embodiment of universal network market system using information 1302 collected from buyers' shopping lists. The generated Customer-Specific Advertisement Magazine 1300 may include a plurality of customer specific advertisements presented as images, tables, figures or other forms.

Based on buyers' shopping lists and buyer and seller tables, the universal network market can search for advertisements of sellers that may be of interest to a given buyer. These advertisements may then be used to generate the customer-specific advertisement magazine for the buyer that includes advertisements 1304 that the buyer may be interested in based on the information obtained from the buyer's shopping list. The customer-specific advertisement magazine may also include advertisements 1306 (e.g., recommendations or recommended advertisements) for products that may be related to the buyer's needed items (i.e., cross-selling advertisements). The generated magazine can then be sent to the buyer over the Internet by email for example or in a hard copy via regular postal service mail. The advertisements can include an coupon identification number 1308 so that a buyer can then make a purchase of the item that takes advantage of the coupon. In an online version, the advertisements may comprise links to the particular page of a seller's website at which the identified product/service is being offered for sale.

As shown in the table 1302, the advertisement column 1314 identifies coupons that are associated with a given item (see the item column 1310) while the status column 1312 may be used to identify the urgency of the need of the buyer for the product. The coupon identifier may be stored in the Advertisement column 1314 with its associated coupon.

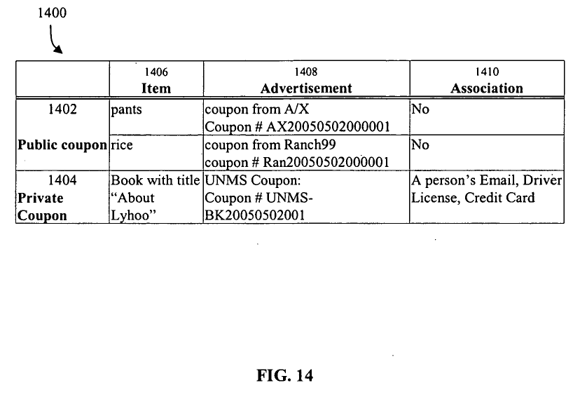

FIG. 14 is an example of a table 1400 that may be used to generate ID-related coupons in accordance with an illustrative embodiment. The Customer-Specific Ads features of allows the distinguishing between public coupons 1402 and private coupons 1404. A public coupon may be defined as coupons that are made available to everyone while a private coupon may be defined as an identifier (ID)-related coupon that can be generated for a particular person(s). Private coupons may be used as a tool to attract users to the universal network market system. An ID-Coupon may be associated an identifier of a given user such as a credit card number, driver license number, e-mail address, cellular phone number of the user. For example, a private coupon of “About Lyhoo” may be given to only employees of the company Lyhoo, Inc. Such a coupon can be associated with the identification of all employees of Lyhoo, Inc. This way the convenience of an electronic coupon may be facilitated while permitting an advertiser control who is to receive and use the coupon. In the present example, employees of Lyhoo, Inc. can simply present an appropriate ID (credit car, driver licenses, email address, cellular text message) to show that they are entitled to the coupon.

As shown in FIG. 14, the table 1400 may include an item column 1406 for identifying items associated with a given advertisement, an advertisement column 1408 for describing the advertisement associated with the item (including its coupon identification number). An associate column 1410 may be used to indicate whether a coupon is public or private by indicating whether or not a certain type of ID is needed to redeem the coupon. For example, the public coupons may have a “No” entry in the association column 1410 to indicate that no special ID is needed to redeem the coupon while the entry in the associate column 1410 for a private coupon may indicate the specific ID (or types of ID) that are needed in order to redeem the coupon.

### An Efficient Advertisement Referral System

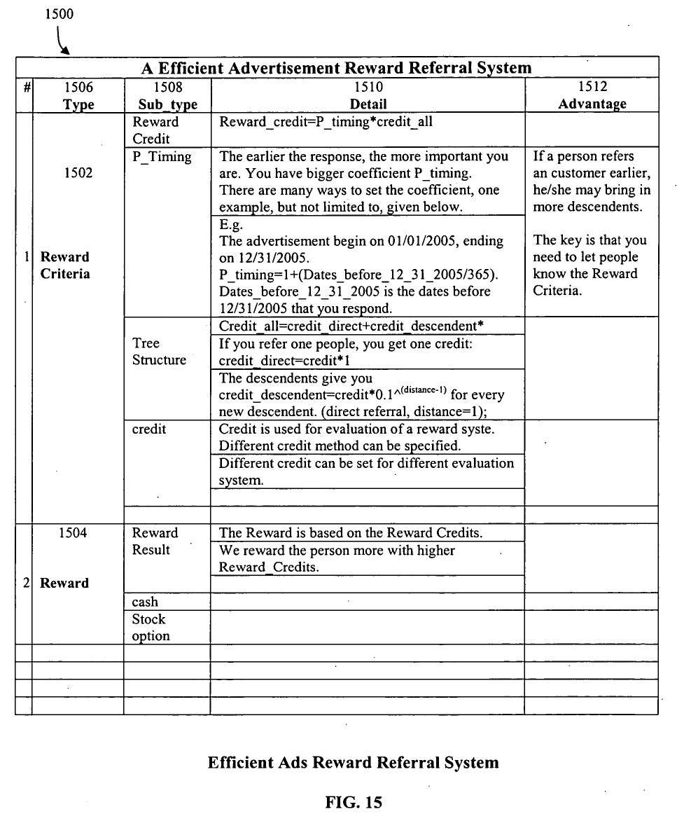

FIG. 15 is a table 1500 that may be used to afford an efficient advertisement reward referral system in accordance with an exemplary embodiment. As shown in FIG. 15, the table 1500 includes rows for different types of reward criteria 1502 and rewards 1504. The table 1500 may also include columns that indicate the type 1506 and sub-types 1508 of reward criteria and rewards. For each sub-type, the table may also include a detail column 1510 for providing details about the specific reward criteria or reward subtype. An advantage column 1512 may also be included for providing details about various reward criteria or rewards. As shown in FIG. 15, reward criteria sub-types can include, reward credits, P_Timing, Tree Structure, and credit while rewards sub-types can include reward results, cash, and stock options.

The details column 1510 may set forth various algorithms used to define the associated sub-type. For example, the reward credit sub-type may be defined as the product of the P_Timing sub-type and the credit_all sub-type. As shown in FIG. 15, P_Timing may be defined by the earliness of the response: the earlier the response, the more important the user is and thus the user receives a higher coefficient P_Timing. P_timing is a scaling factor. In such a manner, early responses by buyers to advertisements can be rewarded more generously than later responses. The credit sub-type can come from both from direct references and indirect references from a direct reference where the measure of the reference is defined by distance. In one embodiment, the less distance the referral is away from the user, the more credit the user will get (i.e., the more direct the referrer, the more credit given).

### Distance

Distance may be further defined as how many “degrees of separation” a given user is from another user. Values may include, for example: one degree away—i.e., directly connected to the given user which means that the user is referred directly by the given user; and two, three or four degrees away: i.e., a friend of a friend is two degrees of distance, one of their friends is three degrees, and one of theirs is four degrees. In one implementation, a user can get credits through all these referred-back distance. If there is more than four degrees of separation, less credit may be awarded for a user referral.

### Linked Rating System

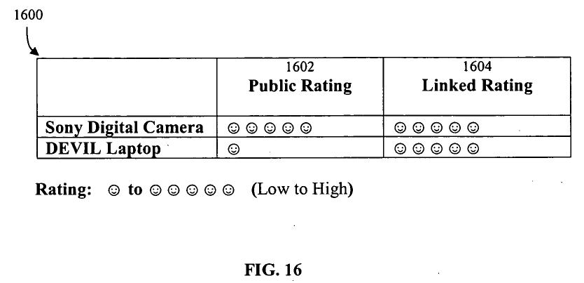

FIG. 16 is an example of an illustrative Linked Raking System 1600 in accordance with an exemplary embodiment. A linked rating may be defined as a rating that is given by the people a user knows and/or trusts. A regular rating system typically rates a product/service based on the number of votes (e.g. pro or con votes) it receives. All votes are equal and the voters don't really know one another. In most cases, people tend to trust their friends or a similar group of people that may have similar ideas and tastes. As a result, such people may tend to give a similar rating to a particular item or service. Linked ratings are those ratings made by users that are linked as previously described (see Distance). As shown in FIG. 16, both public and linked ratings 1602, 1604 of a given product may be presented side by side by the universal network market system so that users can compare the various ratings on a product. In the example shown in FIG. 16, the public and private ratings for a Sony-brand digital camera are both high (i.e., the more faces, the higher the rating) while the Devil-brand laptop has a low public rating but a high linked rating. This indicates that the users that are linked to the given user viewing the rating comparison have given a higher rating to this laptop than the general public. This may be due to, for example, a common preference or need of the linked users that is unique to the linked users and not really found that prevalently in the general public. With such a linked rating, a user may decide to go against public opinion (as represented by the public rating) and purchase a Devil-brand laptop because other users that are linked to this user gave it a high rating.

### A Collection of Menu, Installation Software and Other Product/Service Information

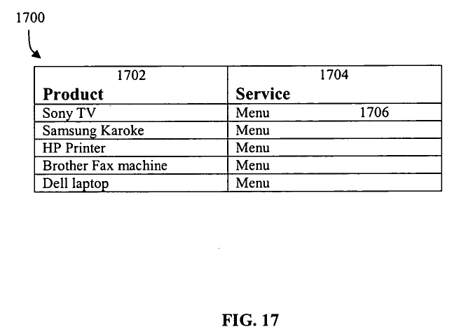

FIG. 17 is an example of a Menu/Installation Software table 1700 that may be afforded by a universal network market system in accordance with one embodiment. In today's society, many products and services come with complicated product menus, installation software and other product/service information. Many people who buy these kinds products do not keep these documents, menus, installation software in an organized manner and, as a result, they cannot find these items when they subsequently need them. As an example, suppose a user purchases a Sony-brand TV, a Samsung-brand Karoke system, an HP-brand printer, a Brother-brand fax machine, and a Dell-brand laptop. One day, the user may discover something wrong with his laptop and needs to use the system installation/recovery disk software to fix it but, of course, the user cannot locate the disk. An embodiment of the universal network market system may use a version of the shopping list to store such kinds of product related information. The universal network market system may collect or at least gather links to the various support documents of a given provider or product 1702 and present the support information 1704 in the table 1700 with user-selectable links 1706 to permit a user to access the support documents. ion of product/service Menu, Installation software and any other product/service information. The support documents may be categorized by the universal network market system according to, for example, company, product type, and service type. Using such a table may make it easier for a user to access such documents.

### Tools and New Service

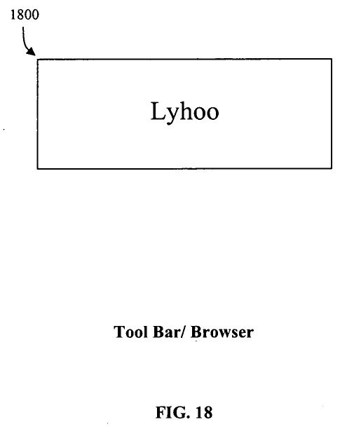

FIG. 18 is an exemplary browser/toolbar 1800 for a universal network market system in accordance with one embodiment. The universal network market system may include interfaces for buyers and sellers. The universal network market system may include software for our buyers and sellers to download to their own computer. Special interfaces may be created for interactive television, interactive voice response, handheld device or any other device. The toolbar 1800 may be created to help provide easy input by a user. When a user views a product, the toolbar may permit a user to decide whether to put a suggested item in the user's shopping list.

As for hardware, a buyer or seller user may use computers, handheld device, phone camera, TV, interactive voice response, call centers, store fronts, ATM, kiosks, digital camera or any other device that can get access to the service provided by the universal network market system. The universal network market system may use digital cameras or other readers to read a bar codes and then automatically connect a user to the universal network market system. Embodiments may also include RFID readers to read RFIDs to connect to the universal network market system.

Currently, advertisements on television is generally broadcast to its entire viewing audience. However, with the development of interactive television and radio, customer-specified-advertisements may be sent to a user using the universal network market system via these interactive channels. For example, a buyer may tell a television that he or she is interested in a BMW car. Then, the television can will select Ads (e.g., promotions, product information, coupon) related to BMW cars and present the selected Ads and other proper Ads to the buyer. A buyer may also choose to view general Ads programs at the same time. In this case, the television may always present Ads to the television viewer. The television viewer may have to view some Ads whether the television viewer chooses Advertising alerts or not. In one embodiment, television viewers may be able to only choose Ads that he/she may like a little more.

Embodiments of the service provided by the universal network market system may be implemented so that they are buyer focused. In such implementations, a buyer can tell the system what they want to buy, and the universal network market system will do the rest for the buyer. Although, the universal network market system may include the step of matching buyer and seller needs once the universal network market system have both side's information.

A buyer or seller may organize/store their information locally at their own computer or other device such as television. The universal network system and its related database can be implemented/stored/executed centrally, distributively, locally, or in any above combination. The client (buyer or seller) may need to update our central universal network system database.

### Exemplary Processes and Environments

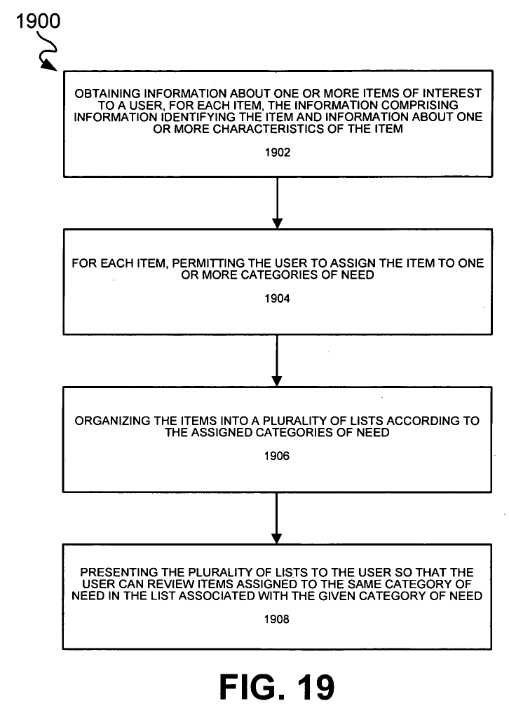

FIG. 19 is a flowchart of a process 1900 for organizing items of interest for presentment to a user in accordance with an exemplary embodiment. In operation 1902, information may be obtained about one or more items of interest to a user (e.g., a buyer). For each item of interest to the user, the obtained information may include information identifying the item (“item identity information,” i.e., what the item is, e.g., rice) and information about one or more characteristics of the item such as, for example, size and/or quantity of the item, a price for the item (e.g.,. a retail price and/or a price at which the buyer would be interested in purchasing the item), a seller, manufacture, designer and/or provider of the item (e.g., Safeway or Armani). In operation 1904, the user, for each item of interest, may be permitted to assign the item to one or more relative categories of need based on, for example, the relative need by the user for the item. In operation 1906, the items may be organized into a plurality of item lists according to the item's assigned categories of need. In operation 1908, the plurality of lists may be presented to the user in a user-selectable format so that the user can select and review items assigned to the same category of need in the list associated with the given category of need.

A network (such as, e.g., the Internet) may be utilized to obtain the information from the user and present the lists to the user. The information may be obtained from the user by presenting, to the user, an interface capable of receiving input about the items from the user. The interface may present graphical images of a plurality of items from which the user can select the items of interest. The interface may also be capable of receiving textual input from the user so that the user can input the specific names of items and their characteristics.

The plurality of lists may include a general list that includes all of the items obtained from the user. The characteristics for which information about the items of interest are obtained may be defined by the user (i.e., user-defined). The categories of need may include a category of items needed immediately (e.g., “My Immediate” list), a category of items needed regularly (e.g., “My Regular” list), a category of items of general interest (e.g., wish list or “My Interested” list) but that not needed regularly or immediately.

The information about the characteristics of the item may also include frequency information about a frequency that the item is purchased by the user. The frequency information may be used to generate a reminder notice that is sent to the user via the network to remind the user that it may be time to purchase the item and replenish the user's supply of that item (i.e., an upcoming “deadline” at which time the supply of the item will need to be replenished). The frequency information may also be used to generate the reminder information is obtained from items associated with a category of regularly needed items (e.g., “My Regular” list). The generating of the reminder notice may include adding an entry for the item into a reminder list (e.g., “My Reminder” list).

Information may be collected about the items obtained from the user from one or more third party sites. User-selectable links to the collected information about the items may then be included in at least one of the generated lists that are presented to the user. After selection of one of these links, at least a portion of the collected information may be presented to the user via the network.

Evaluation or criteria information relating to the items (or features of items) obtained from user may also be collected (e.g., from third party sources) and stored in a database. The collected evaluation information (that is associated with a given item obtained from the user) may then be presented to the user (e.g., after selection of an appropriate link presented in the list in which the item is included) to provide advice to the user regarding the item and product related information that can be used by the user in evaluating whether or not to purchase the given item. The user may be queried (e.g., via the network) for information relating to the user's interest in the given item. This information relating to the user's interest can then be used to generate a recommendation or suggestion to the user about the item (e.g., a list of recommended products that will meet the needs of the user relating to the given item).

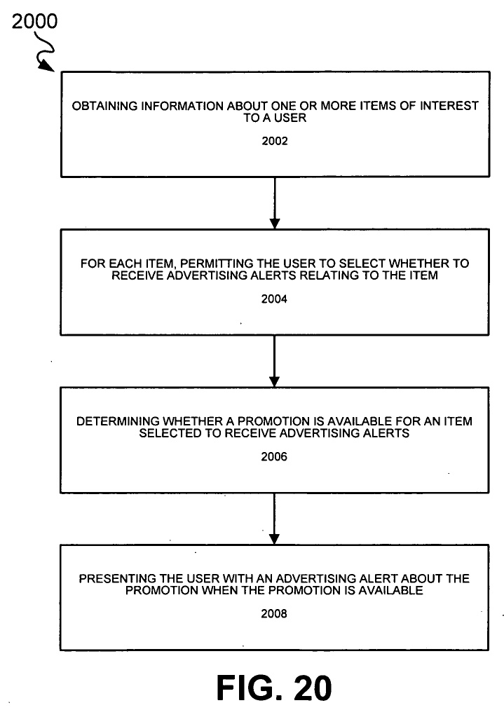

FIG. 20 is a flowchart of a process 2000 for presenting advertising alert to a user based on items of interest to the user in accordance with an exemplary embodiment. In operation 2002, information may be obtained about one or more items of interest to a user (e.g., a buyer). In operation 2004, for each item of interest, the user may be permitted to select whether or not to receive advertising alerts and/or product-information relating to the item. In operation 2006, it may be determined whether a promotion is available for an item selected to receive advertising alerts. In one embodiment, the determination may occur at any time (e.g., whether or not the user is currently/actively accessing the service). In operation 2008, the user may be presented with an advertising alert about the promotion when the promotion is available.

The user may be permitted to specify criteria for selecting promotions in which case, the determination may also include a determination as to whether the available promotion satisfies at least a portion of the criteria specified by the user. The advertising alert may then be presented, for example, for only those promotions that satisfy the at least a portion of the criteria. The advertising alert may be transmitted to a wireless device of the user (e.g., a cell phone, a wireless PDA). The advertising alert may also be presented to the user via a network.

The determination in operation 2006 may also include registering one or more sellers with the universal network market system to permit the seller to submit promotions for goods and services associated with the seller. In such an embodiment, it may be determined whether any of the submitted promotions of the seller matches one of the items selected by the user as an item that the user is interested in receiving advertising alerts for. In such as case, the advertising alert that are actually presented to the user may be associated with at least one submitted promotion that was determined to match the item(s) submitted selected by the user. In one implementation, the user may further be provided with the option to contact the seller of the matching promotion directly via a network rather than having to go through the universal network market system.

In one implementation, one or more third party sites may be searched (e.g., via a network) for promotions that will expire within a predetermined amount of time in the future (i.e., timing-critical promotions that will expire in a short amount of time (i.e., in the near future)). Next, a determination may be made as to whether the promotion is directed to one or more of the items obtained from the user and, if so, an advertising alert may be generated and presented the user that indicates that the timing-critical promotion that will expire in the predetermined amount of time. As an option, timing-critical promotions may be generated for items that the user has chosen not to receive advertising alerts.

Third party sites may be further searched (e.g., via a network) for new update information associated with the item(s) obtained from the user. An alert may then be generated and presented the user that indicates the availability of the new update information.

In one implementation, a magazine/brochure may be generated that contains the promotions determined to be available, and wherein the magazine is presented to the user. The magazine that is generated may be an online magazine that is accessible for viewing via a network such as the Internet. As another option, the magazine may also be distributed as a hard-copy (i.e., paper) document. In any event, the magazine may also contains identifiers associated with the promotions that have been included in the magazine. These identifiers can be used when redeeming the promotion and for bookkeeping purposes in the universal network market system. The magazine may also includes promotions for additional recommended items (e.g., recommended ads) that are selected based on an association to the items for which promotions are determined to be available.

For each item of interest to the user, the obtained information may also include information about one or more characteristics of the item (such as, e.g., size and/or quantity of the item, a price for the item (e.g.,. a retail price and/or a price at which the buyer would be interested in purchasing the item), a seller, manufacture, designer and/or provider of the item (e.g., Safeway or Armani)). In such an embodiment, the determining whether a promotion is available or not may include a search for promotions that relate to the information about the one or more characteristics of the item.

The user may also be permitted to assign each item of interest to one or more relative categories of need (based on the relative need by the user for the item). The assigned items may then be organized into a plurality of item lists according to the item's assigned categories of need. These lists may be presented to the user in a user-selectable format so that the user can select and review items assigned to the same category of need in the list associated with the given category of need. As an option, the advertising alert may be presented in those lists in which the item is assigned.

In one embodiment, the promotion that is determined to be available may require that an identifier associated with the user to be disclosed when redeeming the promotion (i.e., the promotion is a private coupon). In another embodiment, the user may be permitted to forwards the advertising alert to a third party who can then access the promotion utilizing the advertising alert. The user may then be assigned a credit for the access by the third party with the value of the credit being assigned based on at least a degree of relatedness of the third party to the user.

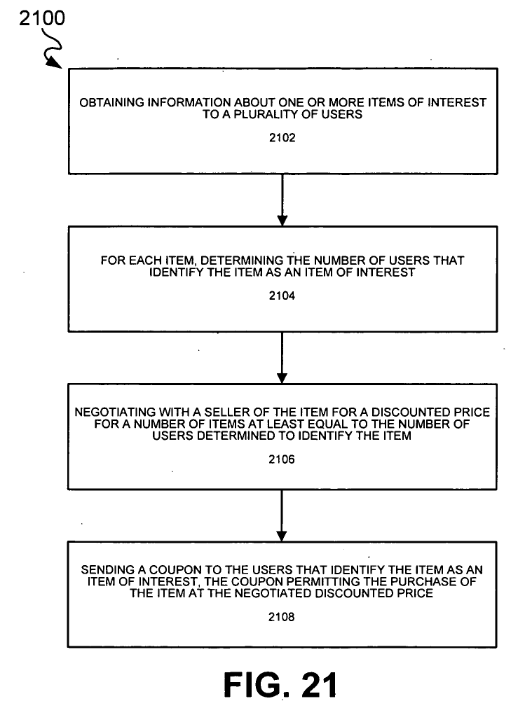

FIG. 21 is a flowchart of a process 2100 for purchasing items in accordance with an exemplary embodiment. In operation 2102, information may be obtained about one or more items of interest to a plurality of users (e.g., a buyer). For each item, the number of users that identify the item as an item of interest may be determined in operation 2104. In operation 2106, negotiations may be conducted with a seller of the item to negotiate a discounted price based on the number of users determined to identify the item. A coupon may then be to the users that identify the item as an item of interest. This coupon permits the users to purchase of the item at the negotiated discounted price upon redemption of the coupon. The coupon may be sent to a wireless device of the users that identify the item as an item of interest. The coupon may also be sent via a network such as the Internet.

As an option, the universal network market system may purchasing the number of items in bulk from the seller on behalf of the users and then sell the items directly to the users. The determination conducted in operation 2104 may be performed for a set of the items of interest that are assigned by the users into a category of items needed immediately by the users. In another embodiment, the items of interest for each user may be organized into a plurality of item lists according to assigned categories of need. These lists may then be presented to the respective user in a user-selectable format so that the user can select and review items assigned to the same category of need in the list associated with the given category of need. The coupon sent to users may be presented in the lists of the users having the item of interest (i.e., those lists that contain the item of interest).

In one implementation, users may be permitted to forward the coupon to a third party. If the third party redeems the coupon when purchasing the item associated with the coupon, the user may be assigned a credit for the redeeming of the coupon by the third party. The value of the credit may be assigned based on a degree of relatedness (i.e., the degree of separation) of the third party to the user.

In one implementation, reviews and critiques made by the users about at least one item may be collected. At least a portion of the reviews may have been made by users that are separated from each other by a predetermined degree of relatedness (i.e., degree of separation) or less (i.e., users that are linked to one another by a predetermined degree of relatedness or less (e.g., if the predetermined degree of relatedness is three degrees of separation, then users that are separated by three, two or one degree of separation would be included)). A user in the group of users that are separated from each other by the predetermined degree of relatedness may then be presented with a “linked” rating for the item based on the portion of reviews that were made by the users separated from each other by the predetermined degree of relatedness. A “general” rating for the item based on all of the reviews for the item may be presented adjacent the “linked” rating so that the user can compare the two ratings to one another.

In one implementation of a universal network market system, a process may be implemented for finding customer orientated Ads. In such an implementation, buyer's information may be obtained about one or more items of interest to a buyer. For each item, the buyer's information may comprise information identifying the item and information about one or more characteristics of the item. Seller's information may then be selected to present to the buyer according to the buyer' information. The buyer's information may comprise information identifying the item, Ads, promotions, coupons, product release, information about one or more characteristics of the item.

In one embodiment, the selected seller's information may be presented to the buyer. In such an embodiment, the presenting can be in the form of text, print, audio, and video, data stream, icons or graphics images with links to host web servers. In another implementation, the presenting and receiving can be through Internet, telephone, e-mail, TV, Interactive TV, interactive voice response (IVR), voice-over IP, call center, store fronts, ATM, kiosks, any hand held device and other platform that can conduct the business. In a further implementation, the presenting can be in the form of serving the buyer the selected seller's information. In yet another implementation, the presenting can be in the form of sending the buyer the selected seller's information.

In one embodiment, selected seller's information, or the buyer's information, or seller's information may be stored in a database. In one implementation, the database may be stored centrally on a network device. In another implementation, the database may be stored locally on a network device. In a further implementation, the database may be stored distributively on network devices, or stored in a network stream.

In one embodiment, a seller's desire—which is the information about items a seller wish to sell or serve—may be received. In such an embodiment, the seller's desire may be treated as seller's information. In another embodiment, the selecting of the seller's information may be based on the buyer's information available on the database, while the buyer is using the network device or not using the network device. In a further embodiment, seller's information may be selected locally. In yet another embodiment, seller's information may be selected distributively over the network. In yet another embodiment, seller's information may be selected centrally.

In one embodiment, a computer or computing machine may select the seller's information. In another embodiment, a human being may select the seller's information manually. In a further embodiment, an easy shopping organizer (e.g., a shopping list) may be provided.

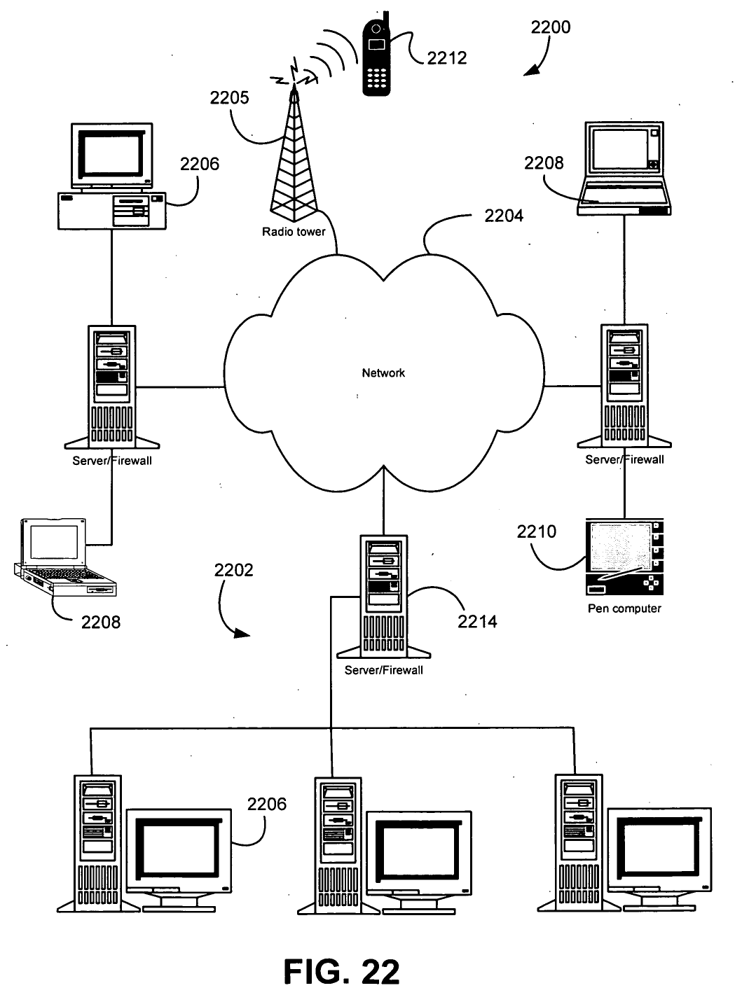

FIG. 22 illustrates an exemplary network system 2200 with a plurality of components 2202 in accordance with one embodiment. As shown, such components include a network 2204 which take any form including, but not limited to a local area network, a wide area network such as the Internet, and a wireless network 2205. Coupled to the network 2204 is a plurality of computers which may take the form of desktop computers 2206, lap-top computers 2208, hand-held computers 2210 (including wireless devices 2212 such as wireless PDA's or mobile phones), or any other type of computing hardware/software. As an option, the various computers may be connected to the network 2204 by way of a server 2214 which may be equipped with a firewall for security purposes. It should be noted that any other type of hardware or software may be included in the system and be considered a component thereof.

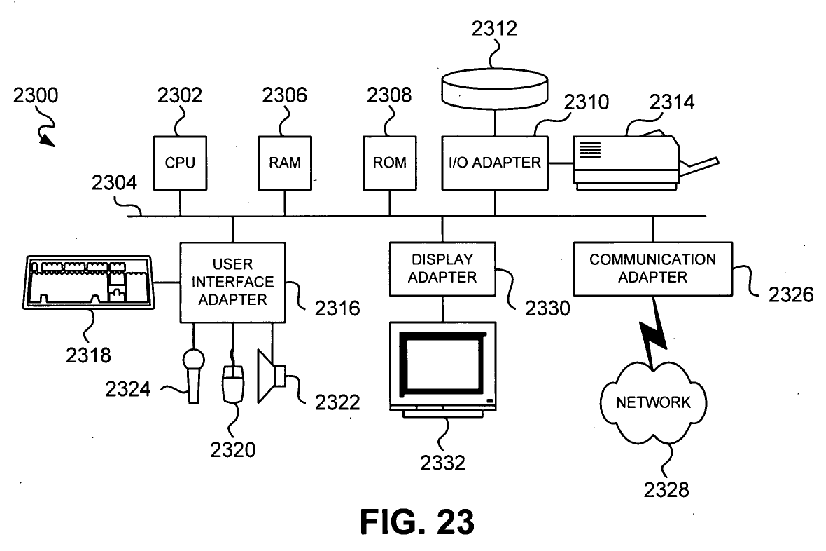

A representative hardware environment associated with the various components of FIG. 22 is depicted in FIG. 23. In the present description, the various sub-components of each of the components may also be considered components of the system. For example, particular software modules executed on any component of the system may also be considered components of the system. In particular, FIG. 23 illustrates an exemplary hardware configuration of a computer 2300 having a central processing unit 2302, such as a microprocessor, and a number of other units interconnected via a system bus 2304. The computer 2300 shown in FIG. 23 includes a Random Access Memory (RAM) 2306, Read Only Memory (ROM) 2308, an I/O adapter 2310 for connecting peripheral devices such as, for example, disk storage units 2312 and printers 2314 to the bus 2304, a user interface adapter 2316 for connecting various user interface devices such as, for example, a keyboard 2318, a mouse 2320, a speaker 2322, a microphone 2324, and/or other user interface devices such as a touch screen or a digital camera to the bus 2304, a communication adapter 2326 for connecting the computer 2300 to a communication network 2328 (e.g., a data processing network) and a display adapter 2330 for connecting the bus 2304 to a display device 2332. The computer may utilize an operating system such as, for example, a Microsoft Windows operating system (O/S), a Macintosh O/S, a Linux O/S and/or a UNIX O/S. Those of ordinary skill in the art will appreciate that embodiments may also be implemented on platforms and operating systems other than those mentioned. One of ordinary skilled in the art will also be able to combine software with appropriate general purpose or special purpose computer hardware to create a computer system or computer sub-system for implementing various embodiments described herein. It should be understood the use of the term logic may be defined as hardware and/or software components capable of performing/executing sequence(s) of functions. Thus, logic may comprise computer hardware, circuitry (or circuit elements) and/or software or any combination thereof.

Embodiments of the present invention may also be implemented using computer program languages such as, for example, ActiveX, Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures.

Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:
Objects can represent physical objects, such as automobiles in a traffic-flow simulation, electrical components in a circuit-design program, countries in an economics model, or aircraft in an air-traffic-control system.
Objects can represent elements of the computer-user environment such as windows, menus or graphics objects.
An object can represent an inventory, such as a personnel file or a table of the latitudes and longitudes of cities.
An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

Some benefits of object classes can be summarized, as follows:
Objects and their corresponding classes break down complex programming problems into many smaller, simpler problems.
Encapsulation enforces data abstraction through the organization of data into small, independent objects that can communicate with each other. Encapsulation protects the data in an object from accidental damage, but allows other objects to interact with that data by calling the object's member functions and structures.
Subclassing and inheritance make it possible to extend and modify objects through deriving new kinds of objects from the standard classes available in the system. Thus, new capabilities are created without having to start from scratch.
Polymorphism and multiple inheritance make it possible for different programmers to mix and match characteristics of many different classes and create specialized objects that can still work with related objects in predictable ways.
Class hierarchies and containment hierarchies provide a flexible mechanism for modeling real-world objects and the relationships among them.
Libraries of reusable classes are useful in many situations, but they also have some limitations. For example:
Complexity. In a complex system, the class hierarchies for related classes can become extremely confusing, with many dozens or even hundreds of classes.
Flow of control. A program written with the aid of class libraries is still responsible for the flow of control (i.e., it must control the interactions among all the objects created from a particular library). The programmer has to decide which functions to call at what times for which kinds of objects.
Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:
Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.
Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.
Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Sun Microsystems defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNLX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requester. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet. OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object. An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Serialization involves saving the current state of an object to a stream, and restoring an equivalent object from that stream. The stream functions as a container for the object. Its contents include a partial representation of the object's internal structure, including variable types, names, and values. The container may be transient (RAM-based) or persistent (disk-based). A transient container may be used to prepare an object for transmission from one computer to another. A persistent container, such as a file on disk, allows storage of the object after the current session is finished. In both cases the information stored in the container can later be used to construct an equivalent object containing the same data as the original. The example code in this article will focus on persistence.

Inheritance may be defined as a relationship that defines one entity in terms of another. Class inheritance defines a new class in terms of one or more parent classes. The new class may inherit its interface and implementation from its parent class(es). The new class is called a subclass or a derived class. Class inheritance may combine interface inheritance and implementation inheritance. Interface inheritance defines a new interface in terms of one or more existing interfaces while implementation inheritance defines a new implementation in terms of one or more existing implementations. In object-oriented programming, inheritance may further be defined as an ability to create new classes (or interfaces) that contain all the methods and properties of another class (or interface), plus additional methods and properties. For example, if class (or interface) “B” inherits from class (or interface) “A”, then class B is said to be derived from class A. Class B may be referred to as a base (or super) class (or interface) for class D. When a class of objects is defined, any subclass that is defined may inherit the definition of one or more general classes. In the case where some modification to the definition is needed in the subclass, new methods and/or properties may be included in the definition.

A bit stream may be defined as a continuous transfer of bits over some medium. For example, a bit stream may comprise a series of transmitted bits through a transmission link.

A superclass (as referred to as a base or parent class) is one from which other classes are derived using inheritance. In class inheritance, the subclass is said to inherit its interface and implementation from its superclass(es). In object orientated programming, a superclass may be a class that is above another class in the class hierarchy. For example, class “A” may be a superclass of class “B” if classes A and B are on the same branch of a class hierarchy tree and class A is higher on that branch than class B.

In general, introspection may comprise the ability of an object to reveal information about itself as an object such as for example, the object's class, superclass), the messages the object is capable of responding to, and the protocols to which the object conforms. In Java, introspection may further comprise a process by which a class is read in order to create a representation of the object's application program interface (API). Introspection may be carried out by the Java Introspector class, which is part of the Java Core Reflection API. Introspection may be used to provide additional information about an object, supplementing information learned by reflection.

Run-time may be defined as a time during which a program is active and being executed or executing (i.e., the time the program is being run).

Design time may be defined as a time during which an application is being built in a development environment/process. Code may be created and edited during design time.

Transmission Control Protocol/Internet Protocol (TCP/IP) is a basic communication language or protocol of the Internet. It can also be used as a communications protocol in the private networks called intranet and in extranet. TCP/IP is a two-layering program. The higher layer, Transmission Control Protocol or TCP, manages the assembling of a message or file into smaller packet that are transmitted over the Internet and received by a TCP layer that reassembles the packets into the original message. The lower layer, Internet Protocol or IP, handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.). Several higher layer application protocols use TCP/IP to get to the Internet. These include the World Wide Web's Hypertext Transfer Protocol (HTTP), the File Transfer Protocol (FTP), Telnet, and the Simple Mail Transfer Protocol (SMTP). These and other protocols are often packaged together with TCP/IP as a “suite.” Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX) is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does). Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Encryption is the conversion of data into a form, called a ciphertext, that cannot be easily understood by unauthorized people. Decryption is the process of converting encrypted data back into its original form, so it can be understood. Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is often included as part of a web browser. The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet. The private key is used to decrypt text that has been encrypted with the public key. Thus, if a first party sends a message to a second party, the recipient second party may be able to find out the first party's public key (but not the first party's private key) from a central administrator and encrypt a reply message back to the first party using the first party's own public key. When the first party receives the reply message, the reply message may be decrypted by the first party with the first party's private key. In addition to encrypting messages (which ensures privacy), a first party may be able authenticate themselves to second party so that the second party can confirm the identity of the first party (and thus know that it is really the first party who sent the message) by using a private key to encrypt a digital certificate. When the second party receives the encrypted digital certificate, the second party may use the first party's public key to decrypt it.

A browser is an application program that provides a way to look at and interact with all the information on the World Wide Web. The word “browser” seems to have originated prior to the Web as a generic term for user interfaces that let you browse (navigate through and read) text files online. A Web browser may be considered a client program that uses the Hypertext Transfer Protocol (HTTP) to make requests of Web servers throughout the Internet on behalf of the browser user. While some browsers also support e-mail (indirectly through e-mail Web sites) and the File Transfer Protocol (FTP), a Web browser may not be required for those Internet protocols and more specialized client programs are more popular.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface. On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. A plug-in application is recognized automatically by the browser and its function is integrated into the main HTML file that is being presented.

Based on the foregoing specification, embodiments of the invention may be implemented using computer programming or engineering techniques including computer software, firmware, hardware or any combination or subset thereof. Any such resulting program—having computer-readable code—may be embodied or provided in one or more computer-readable media, thereby making a computer program product (i.e., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link. An article of manufacture containing the computer code may be made and/or used by executing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

While various embodiments have been described, they have been presented by way of example only, and not limitation. Thus, the breadth and scope of any embodiment should not be limited by any of the above described exemplary embodiments, but should be defined only in accordance with the following claims and their equivalents.

1. A method, comprising:
obtaining information about one or more items of interest to a user;
for each item, permitting the user to select whether to receive advertising alerts relating to the item;
determining whether a promotion is available for an item selected to receive advertising alerts; and
presenting the user with an advertising alert about the promotion when the promotion is available.

2. The method of claim 1, wherein the user is permitted to specify criteria for selecting promotions, and wherein the determining further comprises determining whether the available promotion satisfies at least a portion of the criteria specified by the user, and wherein the advertising alert is presented for promotions that satisfy the at least a portion of the criteria.

3. The method of claim 1, wherein the advertising alert is transmitted to a wireless device of the user.

4. The method of claim 1, wherein the advertising alert is presented to the user via a network.

5. The method of claim 1, wherein the determining further comprises: registering a seller to permit the seller to submit promotions for goods and services associated with the seller, determining whether any of the submitted promotions of the seller matches a said item selected by the user to receive advertising alerts; and wherein the advertising alert presented to the user is associated with at least one submitted promotion that is determined to match a said item submitted selected by the user.

6. The method of claim 5, further comprising permitting the user to contact the seller via a network.

7. The method of claim 1, further comprising searching one or more third party sites for promotions that will expire within a predetermined amount of time, and determining whether the promotion is directed to one or more of the items obtained from the user, and presenting the user with an advertising alert relating to the promotion that will expire in the predetermined amount of time.

8. The method of claim 7, wherein the one or more items to which the promotion includes at least one item that the user chose not to receive advertising alerts.

9. The method of claim 1, further comprising searching one or more third party sites for new update information associated with at least one item obtained from the user and presenting the user with an alert that indicates the availability of the new update information.

10. The method of claim 1, wherein a magazine is generated that contains the promotions determined to be available, and wherein the magazine is presented to the user.

11. The method of claim 10, wherein the magazine comprises an online magazine.

12. The method of claim 10, wherein the magazine contains identifiers associated with the promotions included in the magazine.

13. The method of claim 10, wherein the magazine further includes promotions for additional recommended items that are selected based on an association to the items for which promotions are determined to be available.

14. The method of claim 1, wherein for each item, the information further comprises information about one or more characteristics of the item, and wherein the determining whether a promotion is available includes searching for promotions that relate to the information about the one or more characteristics of the item.

15. The method of claim 1, wherein for each item, the user is permitted to assign the item to one or more categories of need, and wherein the items are organized into a plurality of lists according to the assigned categories of need, and wherein the plurality of lists are presented to the user so that the user can review items assigned to the same category of need in the list associated with the given category of need.

16. The method of claim 15, wherein the advertising alert is presented in the one or more lists in which the item is assigned.

17. The method of claim 1, wherein the promotion that is determined to be available requires an identifier associated with the user to be disclosed when redeeming the promotion.

18. The method of claim 1, wherein the user forwards the advertising alert to a third party, wherein the third party accesses the promotion utilizing the advertising alert, wherein the user is assigned a credit for the access by the third party, a value of the credit being assigned based on at least a degree of relatedness of the third party to the user.

19. A system, comprising:
logic for obtaining information about one or more items of interest to a user;
for each item, logic for permitting the user to select whether to receive advertising alerts relating to the item;
logic for determining whether a promotion is available for an item selected to receive advertising alerts; and
logic for presenting the user with an advertising alert about the promotion when the promotion is available.

20. A computer program product, comprising:
computer code for obtaining information about one or more items of interest to a user;
for each item, computer code for permitting the user to select whether to receive advertising alerts relating to the item;
computer code for determining whether a promotion is available for an item selected to receive advertising alerts; and
computer code for presenting the user with an advertising alert about the promotion when the promotion is available.
